(19) United States
(12) Patent Application Publication
(10) Pub. No.: US 2012/0026064 A1
(43) Pub. Date: Feb. 2, 2012

(54) WIDEBAND ANTENNA USING COUPLING MATCHING

(75) Inventors: Seung-Cheol Lee, Incheon (KR); Byong-Nam Kim, Kyeonggi-do (KR); Jong-Ho Jung, Gyeonggi-do (KR)

(73) Assignee: ACE TECHNOLOGIES CORPORATION, Incheon (KR)

(21) Appl. No.: 13/264,737

(22) PCT Filed: Apr. 14, 2009
(86) PCT No.: PCT/KR2009/001924

§ 371 Date: Oct. 19, 2011

(30) Foreign Application Priority Data
Apr. 14, 2009 (KR) 10-2009-0032377

(51) Int. Cl. H01Q 1/50

(52) U.S. Cl. 343/860

(57) ABSTRACT

A wide-band antenna using coupling matching is disclosed. The antenna may include a first conductive element, which is electrically connected with a ground; a second conductive element, which is electrically connected with a power feed point and formed parallel to the first conductive element with a particular distance in-between; and a third conductive element for emitting an RF signal that extends from the first conductive element, where the first conductive element and the second conductive element have a particular length such that progressive waves are generated and sufficient coupling is achieved. According to certain aspects of the present invention, a internal type multi-band antenna having wide-band characteristics can be provided, by using coupling matching for multi-band design.

### TECHNICAL FIELD

The present invention relates to an antenna, more particularly to an antenna that supports impedance matching for wide-band applications.

### BACKGROUND ART

In current mobile terminals, there is a demand not only for smaller sizes and lighter weight, but also for functions that allow a user access to mobile communication services of different frequency bands through a single terminal. That is, there is a demand for a terminal with which a user may simultaneously utilize signals of multiple bands as necessary, from among mobile communication services of various frequency bands, such as the CDMA service based on the 824˜894 MHz band and the PCS service based on the 1750˜1870 MHz band commercialized in Korea, the CDMA service based on the 832˜925 MHz band commercialized in Japan, the PCS service based on the 1850˜1990 MHz commercialized in the United States, the GSM service based on the 880˜960 MHz band commercialized in Europe and China, and the DCS service based on the 1710˜1880 MHz band commercialized in parts of Europe.

Furthermore, there is a demand for a composite terminal that allows the use of services such as Bluetooth, ZigBee, wireless LAN, GPS, etc. In this type of terminal for using services of multiple bands, a multi-band antenna is needed, which can operate in two or more desired bands. The antennas generally used in mobile terminals include the helical antenna and the planar inverted-F antenna (PIFA).

Here, the helical antenna is an external antenna that is secured to an upper end of a terminal, and is used together with a monopole antenna. In an arrangement in which a helical antenna and a monopole antenna are used together, extending the antenna from the main body of the terminal allows the antenna to operate as a monopole antenna, while retracting the antenna allows the antenna to operate as a λ/4 helical antenna. While this type of antenna has the advantage of high gain, its non-directivity results in undesirable SAR characteristics, which form the criteria for levels of electromagnetic radiation hazardous to the human body. Also, since the helical antenna is formed protruding outwards of the terminal, it is difficult to design the exterior of the terminal to be aesthetically pleasing and suitable for carrying, but a internal structure for the helical antenna has not yet been researched.

The inverted-F antenna is an antenna designed to have a low profile structure in order to overcome such drawbacks. The inverted-F antenna has directivity, and when current induction to the radiating part generates beams, a beam flux directed toward the ground surface may be re-induced to attenuate another beam flux directed toward the human body, thereby improving SAR characteristics as well as enhancing beam intensity induced to the radiating part. Also, the inverted-F antenna operates as a rectangular micro-strip antenna, in which the length of a rectangular plate-shaped radiating part is reduced in half, whereby a low profile structure may be realized.

Because the inverted-F antenna has directive radiation characteristics, so that the intensity of beams directed toward the human body may be attenuated and the intensity of beams directed away from the human body may be intensified, a higher absorption rate of electromagnetic radiation can be obtained, compared to the helical antenna. However, the inverted-F antenna may have a narrow frequency bandwidth when it is designed to operate in multiple bands.

Thus, there is a demand for an antenna that maintains a low profile structure and overcomes the drawback of the inverted-F antenna of narrow band characteristics for more stable operation in multiple bands.

### DISCLOSURE

### Technical Problem

To resolve the problems in prior art described above, an objective of the present invention is to provide an antenna that has wide-band characteristics as well as low profile characteristics.

Another objective of the present invention is to provide an antenna that provides wide-band characteristics using coupling matching.

Additional objectives of the present invention will be obvious from the embodiments described below.

### Technical Solution

To achieve the objectives above, an aspect of the present provides a wide-band antenna using coupling that includes: a first conductive element, which is electrically coupled to a ground; a second conductive element, which is electrically coupled to a feeding point and formed parallel to the first conductive element with a particular distance in-between; and a third conductive element for radiating an RF signal that extends from the first conductive element, where the first conductive element and the second conductive element have a particular length such that traveling wave is generated and sufficient coupling is achieved.

The coupling occurring between the first conductive element and the second conductive element can be used to perform impedance matching.

A bandwidth can be varied in correspondence with the length of the first conductive element and the second conductive element.

The first conductive element and the second conductive element can have a length equal to or greater than 0.1 times the wavelength.

The wide-band antenna can further include a fourth conductive element, which is separated by a particular distance from the second conductive element and electrically coupled to a ground, and a fifth conductive element, which extends from the fourth conductive element and operates as another radiator, where traveling wave is generated and coupling is achieved between the second conductive element and the fourth conductive element, so that coupling matching and coupling power feed are performed between the second conductive element and the fourth conductive element.

Another aspect of the present invention provides a wide-band antenna using coupling that includes: a first conductive element, which is electrically coupled to a ground; a second conductive element, which is electrically coupled to a feeding point and formed parallel to the first conductive element with a particular distance in-between; and a third conductive element for radiating an RF signal that extends from the first conductive element, where the first conductive element and the second conductive element have a length equal to or greater than 0.1 times the wavelength.

Yet another aspect of the present invention provides a wide-band antenna using coupling that includes: a first conductive element, which is electrically coupled to a ground; a second conductive element, which is electrically coupled to a feeding point and formed parallel to the first conductive element with a particular distance in-between; and a third conductive element for radiating an RF signal that extends from the first conductive element, where multiple open stubs are formed on the first conductive element and the second conductive element that protrude between the first conductive element and the second conductive element.

The open stubs protruding from the first conductive element and the second conductive element can mesh with one another.

In certain embodiments, the open stubs can have a uniform width and length. In certain other embodiments, the open stubs can have partially varying widths and lengths.

The wide-band antenna can also include: a fourth conductive element that is separated by a particular distance from the second conductive element and electrically coupled to a ground; and a fifth conductive element that extends from the fourth conductive element and operates as another radiator, where traveling wave is generated and coupling is achieved between the second conductive element and the fourth conductive element so that coupling matching and coupling power feed are performed between the second conductive element and the fourth conductive element.

### Advantageous Effects

Certain aspects of the present invention can provide an antenna that has wide-band characteristics as well as low profile characteristics.

### DESCRIPTION OF DRAWINGS

FIG. 1 schematically illustrates the structure of an internal wide-band antenna using coupling according to a first disclosed embodiment of the present invention.

FIG. 2 illustrates an example of an internal wide-band antenna using coupling according to the first disclosed embodiment of the present invention implemented on a carrier.

FIG. 3 illustrates S11 parameters in relation to the lengths of the first conductive element and the second conductive element in an antenna according to the first disclosed embodiment of the present invention.

FIG. 4 schematically illustrates a wide-band antenna using coupling according to a second disclosed embodiment of the present invention.

FIG. 5 illustrates an example of an antenna according to the second disclosed embodiment of the present invention implemented on an antenna carrier.

FIG. 6 schematically illustrates a wide-band antenna using coupling according to a third disclosed embodiment of the present invention.

FIG. 7 illustrates an example of an antenna according to the third disclosed embodiment of the present invention implemented on an antenna carrier.

FIG. 8 schematically illustrates a wide-band antenna using coupling according to a fourth disclosed embodiment of the present invention.

FIG. 9 illustrates an example of an antenna according to the fourth disclosed embodiment of the present invention implemented on an antenna carrier.

### MODE FOR INVENTION

The wide-band antenna using coupling according to certain embodiments of the present invention will be described below in more detail with reference to the accompanying drawings.

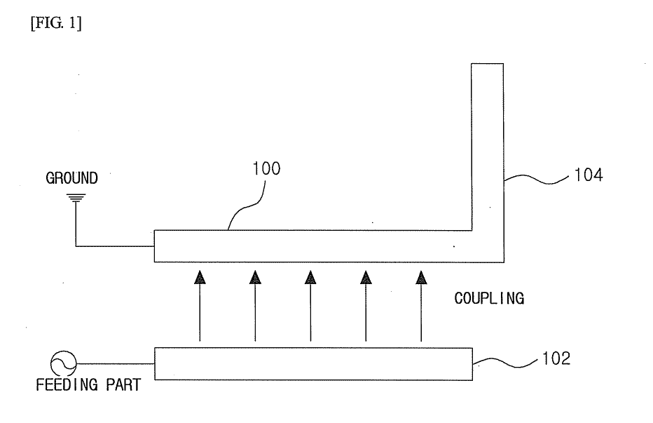

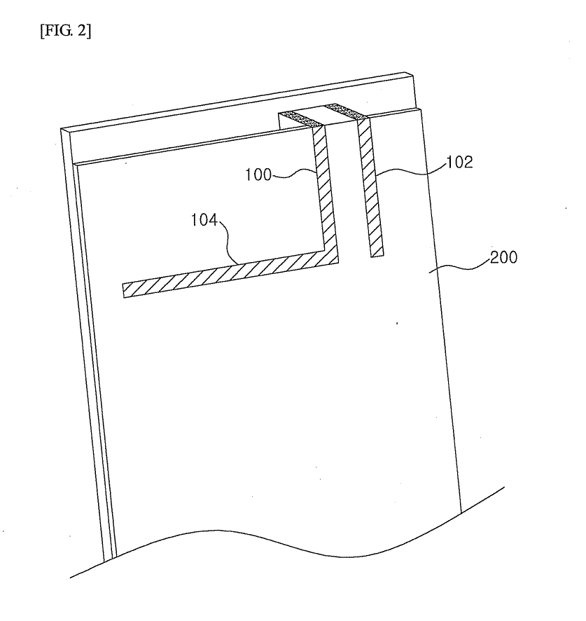

FIG. 1 schematically illustrates the structure of an internal wide-band antenna using coupling according to a first disclosed embodiment of the present invention, and FIG. 2 illustrates an example of a internal wide-band antenna using coupling according to the first disclosed embodiment of the present invention implemented on a carrier.

Referring to FIG. 1, a wide-band antenna according to the first disclosed embodiment of the present invention may include a first conductive element 100 electrically coupled to a ground, a second conductive element 102 electrically coupled to a feeding part, and a third conductive element 104 extending from the first conductive element 100.

The first conductive element 100 coupled to the ground and the second conductive element 102 coupled to the feeding part may be formed parallel to each other, separated by a particular distance. Traveling waves may be generated between the first conductive element 100 and the second conductive element 102, which are formed to a particular length, and feeding by coupling may occur from the second conductive element 102 to the first conductive element 100.

In order to obtain a sufficient amount of coupling, a particular length may be needed for the first conductive element 100 and the second conductive element 102. Longer lengths can provide wider bandwidths.

The first conductive element 100 and second conductive element 102 formed parallel to each other with a particular distance in-between may serve as an impedance matching part and a feeding part, where impedance matching may be obtained by way of the coupling.

The third conductive element 104 may extend from the first conductive element 100, which is concerned with coupling matching, where the third conductive element 104 may operate as a radiator. The radiation frequency of the antenna may be determined by the lengths of the first conductive element 100 and the third conductive element 104.

Referring to FIG. 2, an example is illustrated in which the antenna shown in FIG. 1 is implemented on a carrier 200. The carrier 200 may be coupled to the board 202 of a terminal, where the first conductive element 100 may be electrically is coupled to a ground formed on the board 202 of the terminal, and the second conductive element 102 may be electrically coupled to a feeding line formed on the board 202.

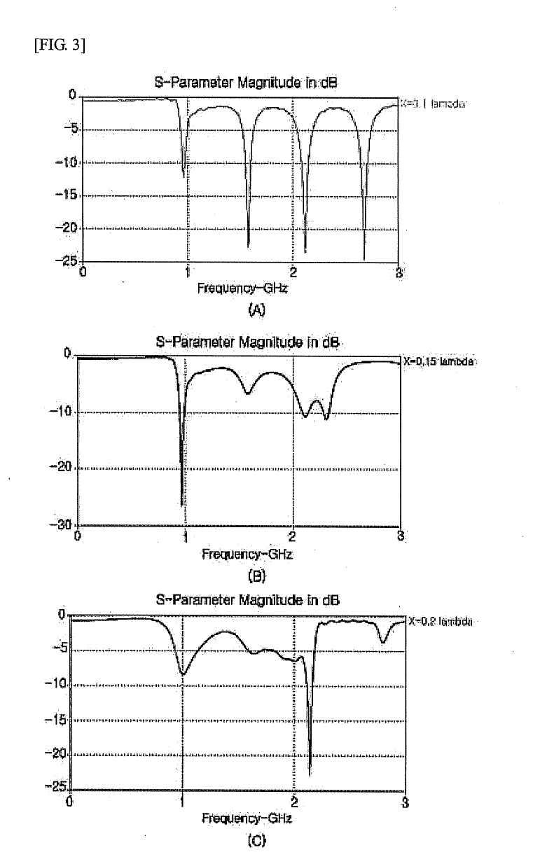

FIG. 3 illustrates S11 parameters in relation to the lengths of the first conductive element and the second conductive element in an antenna according to the first disclosed embodiment of the present invention.

Graph (A) in FIG. 3 shows S11 parameters when the lengths of the first conductive element and second conductive element are 0.05 times the wavelength, graph (B) shows S11 parameters when the lengths of the first conductive element and second conductive element are 0.07 times the wavelength, and graph (C) shows S11 parameters when the lengths of the first conductive element and second conductive element are 0.1 times the wavelength.

Referring to FIG. 3, it can be observed that wider band characteristics can be obtained when the lengths of the first conductive element and second conductive element are longer. According to an embodiment of the present invention, better wide-band characteristics may be obtained, compared to a typical PIFA, when the lengths of the first conductive element and second conductive element are 0.1 times the wavelength.

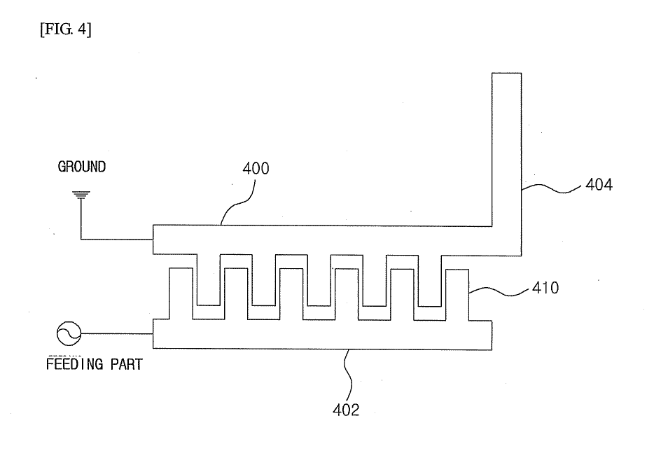

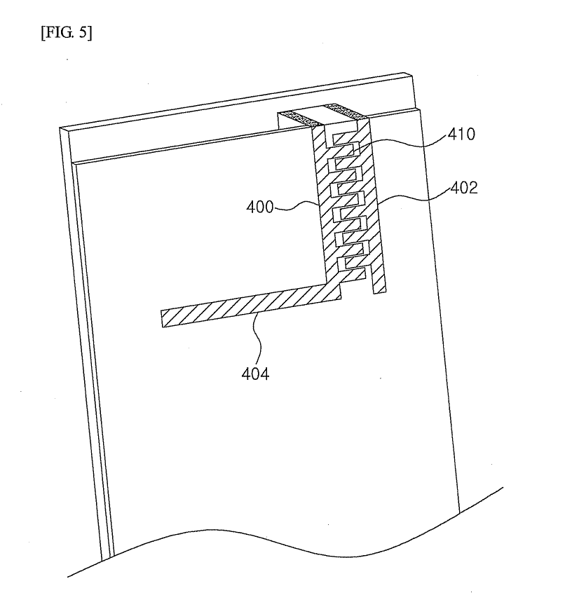

FIG. 4 schematically illustrates a wide-band antenna using coupling according to a second disclosed embodiment of the present invention, and FIG. 5 illustrates an example of an antenna according to the second disclosed embodiment of the present invention implemented on an antenna carrier.

Referring to FIG. 4, an antenna according to the second disclosed embodiment of the present invention may include a first conductive element 400 electrically coupled to a ground, a second conductive element 402 electrically coupled to a feeding part, a third conductive element 404 extending from the first conductive element 400, and a plurality of open stubs 410 protruding from the first conductive element 400 and second conductive element 402.

The second disclosed embodiment, as illustrated in FIG. 4 and FIG. 5, differs from the first disclosed embodiment in that the structure includes the plurality of open stubs, which protrude from the first conductive element 400 and second conductive element 402 between the first conductive element 400 and second conductive element 402. While FIG. 4 and FIG. 5 illustrate an example in which the open stubs 410 are rectangular in form, it will be apparent to the skilled person that the open stubs can be formed in various other shapes.

As observed in FIG. 3, impedance matching is possible for a wider band when the lengths of the first conductive element and second conductive element are longer. This means that impedance matching is possible for a wider band when the capacitance between the first conductive element and second conductive element is increased. Thus, besides increasing the lengths of the first conductive element and second conductive element, it is still possible to obtain impedance matching for a wider band with shorter distance between the first conductive element and the second conductive element than with longer distance between the first conductive element and the second conductive element.

In FIG. 4, the open stubs protruding from the first conductive element 400 and second conductive element 402 may substantially increase the electrical length of the first conductive element 400 and second conductive element 402, thereby allowing impedance matching for a broader band even with a limited length.

Also, as illustrated in FIG. 4, the open stubs protruding from the first conductive element 400 and second conductive element 402 may protrude meshing with one another and generally forming a comb-shaped structure. When the open stubs 410 protrude from the first conductive element 400 and second conductive element 402 in this manner to mesh with one another, the distance between the first conductive element 400 and the second conductive element 402 may be reduced, so that a greater capacitance value may be obtained during the coupling matching, and the impedance matching may be obtained for a wider band.

That is, the structure having plurality of open stubs protruding from the first conductive element and second conductive element and meshing with one another can not only substantially increase the electrical length of the first conductive element and second conductive element, but also reduce the distance between the first conductive element and second conductive element, so that a longer electrical length and a larger capacitance component may be obtained, which allow impedance matching for wider band even with a limited size.

The third conductive element 404 may extend from the first conductive element 400, operating as a radiator as in the first disclosed embodiment, and feeding signals may be provided by coupling from the second conductive element 402.

While the third conductive element 104, 404, which may serve as a radiator in the first and second disclosed embodiments, has been illustrated as having a linear form, this is merely an example, and it will be apparent to the skilled person that the radiator can have various other shapes, such as an “L” shape and a meandering shape. Also, while FIG. 1 through FIG. 5 illustrate examples in which there is a single third conductive element operating as a radiator, it will be apparent to the skilled person that multiple radiators can be employed.

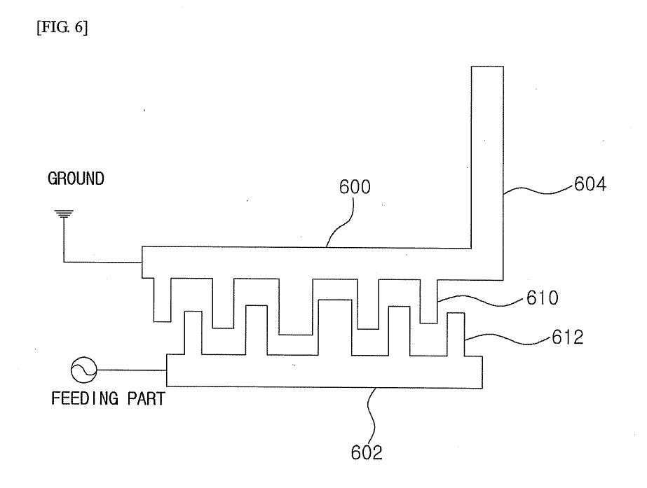

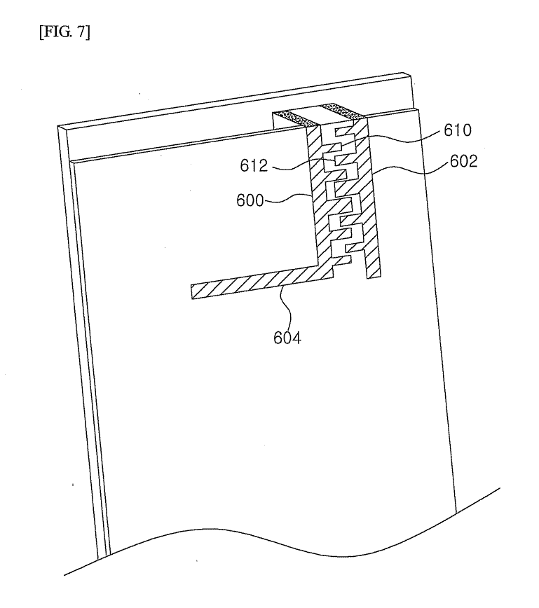

FIG. 6 schematically illustrates a wide-band antenna using coupling according to a third disclosed embodiment of the present invention, and FIG. 7 illustrates an example of an antenna according to the third disclosed embodiment of the present invention implemented on an antenna carrier.

Referring to FIG. 6 and FIG. 7, an antenna according to the third disclosed embodiment of the present invention may include a first conductive element 600 electrically connected with a ground, a second conductive element 602 electrically connected with a power feed part, a third conductive element 604 extending from the first conductive element 600, a multiple number of first open stubs 610 protruding from the first conductive element 600, and a multiple number of second open stubs 612 protruding from the second conductive element 602.

The third disclosed embodiment, as illustrated in FIG. 6 and FIG. 7, differs from the second disclosed embodiment in that the shapes of the open stubs 610, 612 protruding from the first conductive element 600 and second conductive element 602 are different. In the second disclosed embodiment, the widths and lengths of the open stubs 410 protruding from the first conductive element 400 and second conductive element 402 may be constant. That is, whereas the protruding open stubs 410 in the second disclosed embodiment may be formed uniformly, the open stubs 610, 612 in the third disclosed embodiment may not be formed uniformly.

Referring to FIG. 6, the first open stubs 610 that protrude from the first conductive element 600 may be structured to increase in width and length and then decrease again, and the second open stubs 612 that protrude from the second conductive element 602 may be structured to increase in width and length and then decrease again, also.

By thus varying the widths and lengths of the open stubs protruding from the first conductive element 600 and second conductive element 602, the capacitance values for coupling may be diversified. When the capacitance values between the first conductive element 600 and second conductive element 602 are diversified, it is possible to implement impedance matching for a wider band.

The varying structure of open stubs 610, 612 illustrated in FIG. 6 and FIG. 7 is merely an example, and it will be apparent to the skilled person that the widths and lengths of the open stubs 610, 612 can be varied in a various ways. For example, one design can have the first open stubs varying in width only with the lengths remaining constant, while another design can have just one of the first open stubs and second open stubs only varying in width and length.

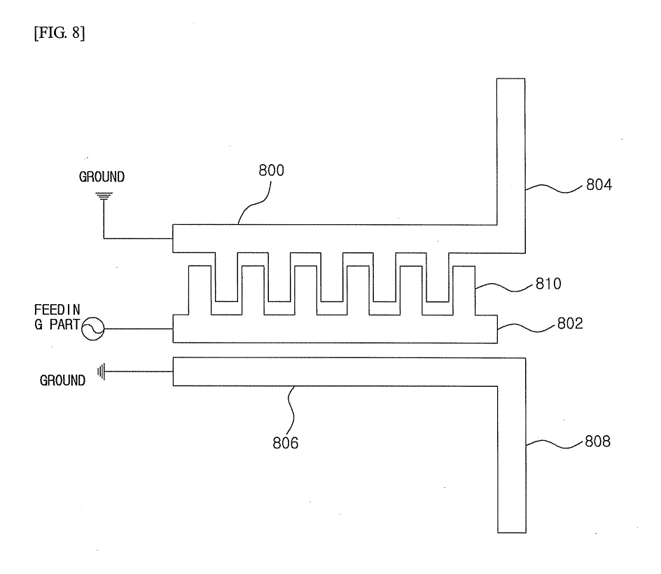

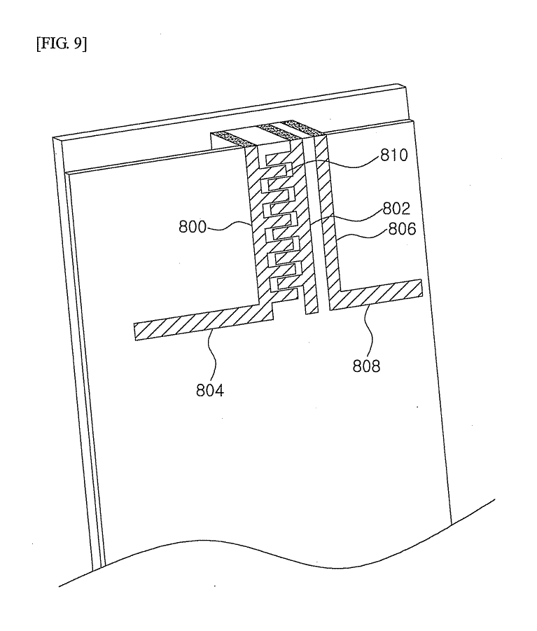

FIG. 8 schematically illustrates a wide-band antenna using coupling according to a fourth disclosed embodiment of the present invention, and FIG. 9 illustrates an example of an antenna according to the fourth disclosed embodiment of the present invention implemented on an antenna carrier.

Referring to FIG. 8, an antenna according to the fourth disclosed embodiment of the present invention can include a first conductive element 800 electrically coupled to a ground, a second conductive element 802 electrically coupled to a feeding part, a third conductive element 804 extending from the first conductive element 800, a fourth conductive element 806 separated from the first and second conductive elements and electrically coupled to a ground, a fifth conductive element 808 extending from the fourth conductive element 806, and plurality of open stubs 810 protruding from the first conductive element 800 and second conductive element 802 between the first conductive element 800 and second conductive element 802.

The fourth disclosed embodiment, as illustrated in FIG. 8 and FIG. 9, differs from the third disclosed embodiment in that the fourth conductive element 806 and the fifth conductive element 808 are added. The fourth conductive element 806 may operate as another impedance matching/feeding part, by coupling with the second conductive element 802, and the fifth conductive element 808 extending from the fourth conductive element 806 may operate as another radiator.

That is, when designing an antenna to have multi-band characteristics, it is possible to radiate RF signals in another band, by adding the fourth conductive element 806, which is arranged at a particular distance from the second conductive element coupled to a feeding part, and the fifth conductive element 808, which extends from the fourth conductive element.

While FIG. 8 and FIG. 9 are shown without a matching and power feed structure that uses open stubs between the second conductive element 802 and the fourth conductive element 806, it will be apparent to the skilled person that the matching and power feed structure using open stubs can also be formed between the second conductive element 802 and fourth conductive element 806.

Furthermore, while FIG. 8 and FIG. 9 illustrate an example in which the fourth conductive element 806 receives power feed from the second conductive element 802, which is connected with the power feed part, it will be apparent to the skilled person that the fourth conductive element 806 can receive coupling power feed from the first conductive element 800, which receives coupling power feed from the second conductive element 802.

1. A wide-band antenna using coupling, the wide-band antenna comprising:
a first conductive element electrically coupled to a ground;
a second conductive element electrically coupled to a feeding point, the second conductive element formed parallel to the first conductive element with a particular distance in-between; and
a third conductive element for radiating an RF signal, the third conductive element extending from the first conductive element,
wherein, the first conductive element and the second conductive element have a particular length such that traveling wave is generated and sufficient coupling is achieved.

2. The wide-band antenna according to claim 1, wherein impedance matching is performed by way of the coupling occurring between the first conductive element and the second conductive element.

3. The wide-band antenna according to claim 2, wherein a bandwidth is varied in correspondence with the length of the first conductive element and the second conductive element.

4. The wide-band antenna according to claim 1, wherein the first conductive element and the second conductive element have a length equal to or greater than 0.2 times wavelength corresponding to a frequency used.

5. The wide-band antenna according to claim 1, further comprising:
a fourth conductive element separated by a particular distance from the second conductive element and electrically coupled to a ground; and
a fifth conductive element extending from the fourth conductive element and operating as another radiator,
wherein traveling wave is generated and coupling is achieved between the second conductive element and the fourth conductive element so that coupling matching and coupling feeding are performed between the second conductive element and the fourth conductive element.

6. A wide-band antenna using coupling, the wide-band antenna comprising:
a first conductive element electrically coupled to a ground;
a second conductive element electrically coupled to feeding point, the second conductive element formed parallel to the first conductive element with a particular distance in-between; and
a third conductive element for radiating an RF signal, the third conductive element extending from the first conductive element,
wherein the first conductive element and the second conductive element have a length equal to or greater than 0.1 times a wavelength corresponding to a frequency used.

7. A wide-band antenna using coupling, the wide-band antenna comprising:
a first conductive element electrically coupled to a ground;
a second conductive element electrically coupled to a feeding point, the second conductive element formed parallel to the first conductive element with a particular distance in-between; and
a third conductive element for radiating an RF signal, the third conductive element extending from the first conductive element,
wherein, the first conductive element and the second conductive element have a plurality of open stubs formed thereon, the open stubs protruding between the first conductive element and the second conductive element.

8. The wide-band antenna according to claim 7, wherein the open stubs protruding from the first conductive element and the second conductive element mesh with one another.

9. The wide-band antenna according to claim 7, wherein the open stubs have a uniform width and length.

10. The wide-band antenna according to claim 9, wherein the open stubs have partially varying widths and lengths.

11. The wide-band antenna according to claim 7, further comprising:
a fourth conductive element separated by a particular distance from the second conductive element and electrically connected with a ground; and
a fifth conductive element extending from the fourth conductive element and operating as another radiator,
wherein traveling wave is generated and coupling is achieved between the second conductive element and the fourth conductive element so that coupling matching and coupling power feed are performed between the second conductive element and the fourth conductive element.
